(19) United States
(12) Patent Application Publication
(10) Pub. No.: US 2004/0122830 A1
(43) Pub. Date: Jun. 24, 2004

(54) System landscape definition using system objects hierarchy

(75) Inventors: Ilan Schwartz, Raanana (IL); Guy Shalev, Herzliya (IL); David Brutman, Tel Aviv (IL); Eylon Steiner, Ra'anana (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SAP Aktiengesellschaft, Walldorf (DE)

(21) Appl. No.: 10/610,839

(22) Filed: Jun. 30, 2003

Related U.S. Application Data
(60) Provisional application No. 60/435,489, filed on Dec. 20, 2002.

(51) Int. Cl. G06F 7/00

(52) U.S. Cl. 707/100

(57) ABSTRACT

Interfaces to systems are defined by system files, which inherit attributes of one or more templates in a hierarchy. An access system might provide access and presentation of data to users wherein data is at least in part extracted from a plurality of external applications. The access system comprises storage for a plurality of system templates, storage for a plurality of system definitions, wherein a system definition includes properties and attributes usable to access an external application from a plurality of external applications to obtain data and wherein at least one system definition has at least one of properties or attributes that are inherited from a system template referenced from the plurality of system templates, and storage for a plurality of system connectors, wherein a system connector provides an interface to one of the plurality of external applications. The system connectors might be referenced by a system definition using an alias.

### CROSS-REFERENCES TO RELATED APPLICATION(S)

The present application claims the benefit of priority under 35 USC §119 from U.S. Provisional Patent Application No. 60/435,489 entitled “SYSTEM LANDSCAPE DEFINITION USING SYSTEM OBJECTS HIERARCHY,” filed on Dec. 20, 2002, the disclosure of which is hereby incorporated by reference in its entirety for all purposes.

### BACKGROUND OF THE INVENTION

The present invention relates generally to data access systems and more specifically to data access systems that connect to external applications to extract data therefrom.

In a data access system, a user typically operates a client having user interface elements and connections to a server that serves the client with data. In some cases, all the data to be presented in the user interface is not available at the server, so the server will have to obtain that data from an external application.

With an external application arrangement, the server operates some software (and/or hardware as needed) to request data from the external application, receive the data, format the data, and provide it to its client. The typical approach is for the server to have interfaces for each of the external applications. This entails much customization and can create maintenance headaches when aspects of the external applications change.

To allow designers to connect a server component to an external application without detailed programming of a server-application connector, the designer might set up a system object that encapsulates all of the details of interacting with an external application. A problem with typical system objects is that they each have to be customized to their particular use and when something changes that affects many system objects, they all have to be changed. A typical change would affect many system objects, as the definition of one external system likely shares many attributes with other external systems, but not all (so separate system objects are needed).

Additional complications arise in determining which users and/or administrators control which system objects.

The present invention addresses at least some of these shortcomings.

### BRIEF SUMMARY OF THE INVENTION

Interfaces to systems are defined by system files, which inherit attributes of one or more system templates in a hierarchy. An access system might provide access and presentation of data to users wherein data is at least in part extracted from a plurality of external applications. The access system comprises storage for a plurality of system templates, storage for a plurality of system definitions, wherein a system definition includes properties and attributes usable to access an external application from a plurality of external applications to obtain data and wherein at least one system definition has at least one of properties or attributes that are inherited from a system template referenced from the plurality of system templates, and storage for a plurality of system connectors, wherein a system connector provides an interface to one of the plurality of external applications. The system connectors might be referenced by system definitions using aliases.

Other features and advantages of the invention will be apparent in view of the following detailed description and preferred embodiments.

### BRIEF DESCRIPTION OF THE DRAWINGS

FIG. 1 illustrates a high-level view of an access system that might use elements of the present invention.

FIG. 2 illustrates a conventional approach to external application interfacing.

FIG. 3 illustrates a system template hierarchy according to embodiments of the present invention.

FIG. 4 illustrates a process for creating a system object from a system template.

FIG. 5 illustrates an example of a system landscape catalog structure.

Appendix A illustrates an example system object in XML format.

### DETAILED DESCRIPTION OF THE INVENTION

The present invention has many applications, as will be apparent after reading this disclosure. In describing an embodiment of a data access system according to the present invention, only a few of the possible variations are described. Other applications and variations will be apparent to one of ordinary skill in the art, so the invention should not be construed as narrowly as the examples, but rather in accordance with the appended claims.

In embodiments of an access system according to the present invention, external systems are interfaced to the access system. The access system can be a client-server system, or a one-tier integrated system with external connectors. The access system can be for various purposes, but for the examples used herein, the access system is a portal system. A portal system provides its users a construct wherein data from disparate locations can be collected and viewed. The offerings of SAP AG provide examples of portal systems.

The external systems can be databases or other functionality, but can be generally thought of as applications. For example, if a portal system is to access data stored in an external database, the interface is likely to be through a database application that controls that external database. However, in other instances, the portal system accesses the data directly. For simplicity, each external system that provides data, receives data, or performs some other action in response to a request from the portal system, is referred to herein as an external application.

The portal system accesses an external application using a system definition and a system connector. The system definition defines how the external application is to be accessed and the system connector provides the actual lower level access to the external application. The system definitions might be themselves stored in a database. The collection of objects and definitions for a particular system can be thought of as the “system landscape”.

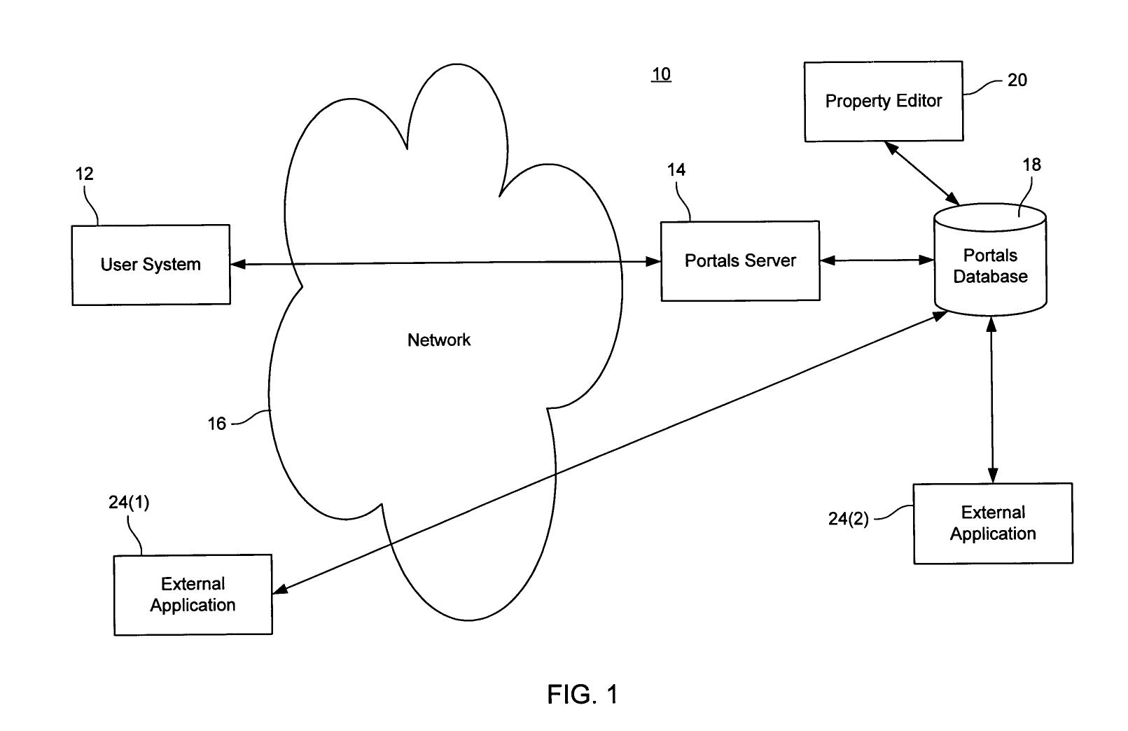

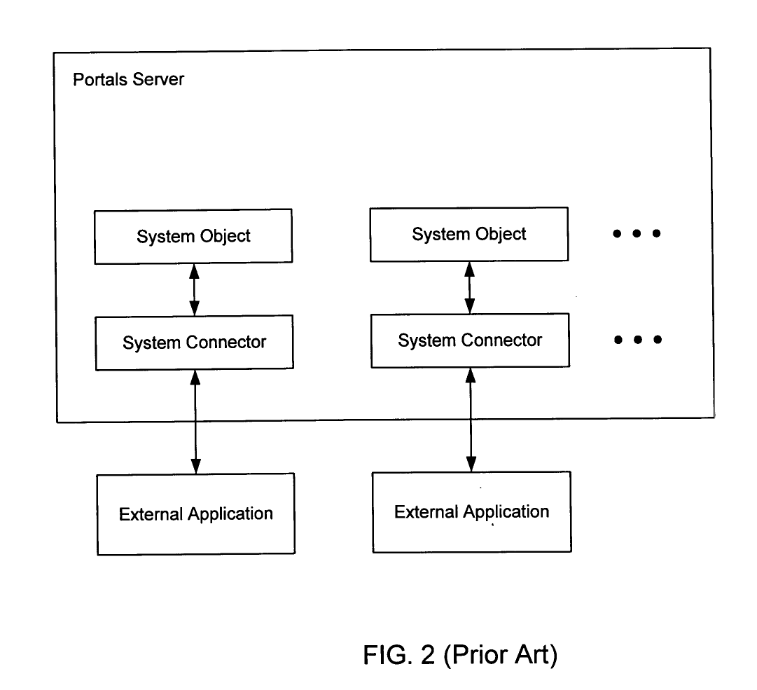

FIG. 1 illustrates a high-level view of one such access system 10. There, user systems 12 interact with a portal server 14 via a network 16. User systems 12 might be controlled by human users or by automated users. For example, a user might be a person and the user system a personal computer running a browser, or the user might be a computer running a script. From the perspective of portal server 14, it might be configured to operate the same way regardless of the type of user accessing it.

Portal server 14 is also shown coupled to a portals database 18, which can be accessed by a property editor 20. Portals database 18 also interacts with external applications 24. Note that the external applications might be across the network 16 from portal server 14, as is the case for external application 24(1), but other applications, such as external application 24(2) might be local (or separated by another network, not shown). A common example for network 16 is the global internetwork of networks generally referred to as the Internet and operating using HTTP/FTP/AFS/etc. over TCP/IP, but other networks and/or protocols might be used as well.

The external applications 24 might be legacy systems, such as mainframe on-line transaction processing systems, data warehouses, on-line analysis processing systems, and the like. The external applications 24 might also include other systems that stand alone for some operations and are accessed via the portal server for other operations. Yet other examples of external applications 24 include applications that are not controlled or operated by the portal server operator, thus necessitating some sort of external access. For example, portal server 14 might include information derived from a web site (a computer or collection of computers serving web pages from a set of related URLs) and obtain that information by accessing those web pages, e.g., by making HyperText Transport Protocol (HTTP) requests of an HTTP server.

With only a few external applications, the conventional approach of having a system object, supporting a system definition and a system connector for each external application is workable, but for most enterprises, their portal server will need access to many external applications. One improvement of the access system described herein over that conventional approach is the use of hierarchical system definition, using system definitions and hierarchies of system templates.

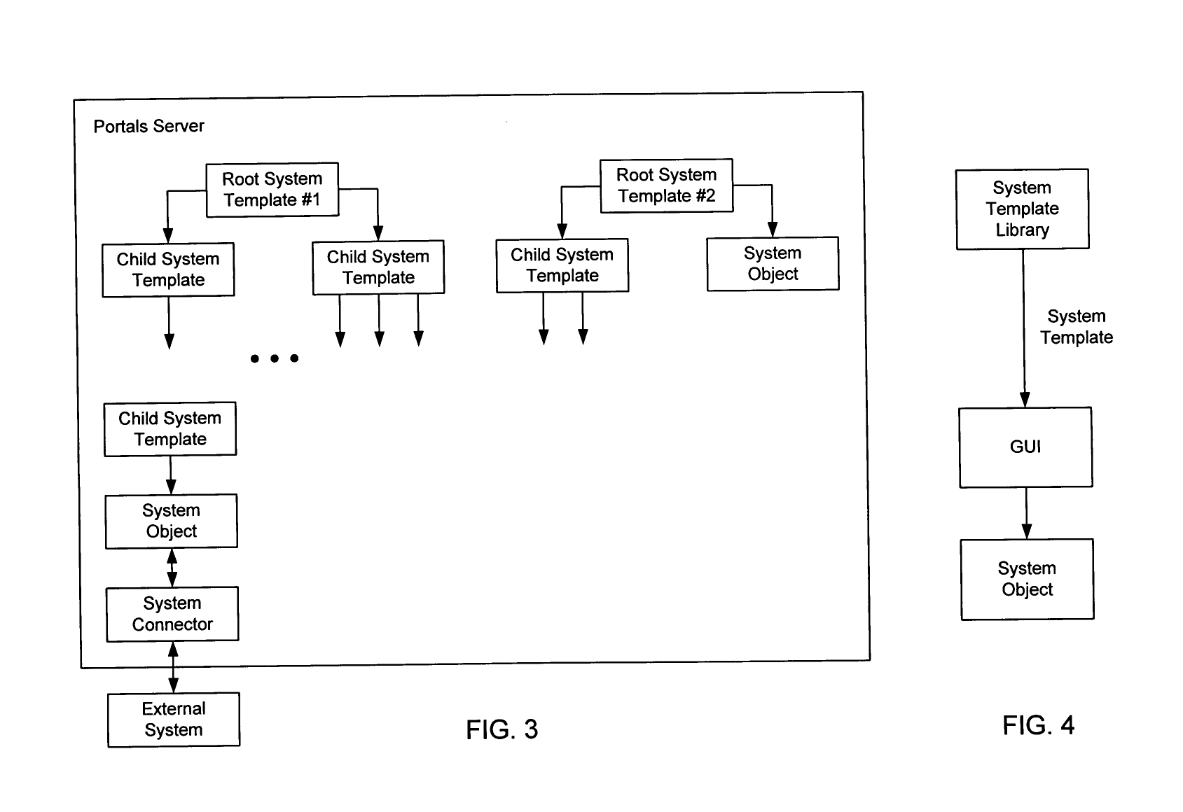

FIG. 3 illustrates such a system template hierarchy. As shown there, system templates inherit from higher order system templates, up to a root system template and a system object inherits from a system template and then interfaces to a system connector, which interfaces with an external application. It is possible to use a system template for access to an external system, but system objects should be used for that. As used in these examples, the system object embodies a system definition. Thus, where system definitions might be present in portals database 18 for many, many systems, system objects might only be instantiated for those external applications needing to be interfaced to.

Because a system definition can inherit properties and attributes from a system template and system templates can in turn inherit properties and attributes of higher order system templates, the system definitions are easier to maintain. System templates and system definitions form a template hierarchy. In some implementations, a system definition object only differs from a system template object in that the system definition object cannot be used as a basis for lower order system definition objects or system template objects. This distinction provides control over the use of system definitions.

One reason why it might be useful to have system objects being the leaves of the hierarchy is for user control. A system landscape might comprise some system objects and system templates that inherit attributes or properties from system templates wherein it is preferred and that other users not make reference to a set of attributes or properties. In those instances, the set of attributes or properties would be included in a system object.

If the system definitions and system templates are stored in a directory structure with user controls (such as read, write, modify controls), an administrator can create a structure that is usable as a system definition in a read-only directory to limit the ability of other users to modify that system definition. If the object is a system definition and not a system template, then users would also be unable to reference that definition to create variants of it. Permissions for an object might be inherited from the folder in which the object resides rather than the object itself. This would make possible customizations wherein, for example, different users see different systems even though they apparently are operating with the same portal components.

A system template or system definition describes aspects of external applications with properties and attributes, where the attributes ascribe values to properties. Thus, an external application might be defined solely by a set of name-value (property=value) tuples. Examples of such tuples are shown in Appendix A. A system definition can be used to inform a system connector how to connect to the external application, extract data therefrom and otherwise communicate with the external application.

The system connector can be used to describe the external system such that a portal component (code run by the portal server) can be connected to the external application at runtime. In a typical arrangement, system connectors are not visible from a portal interface but remain below the surface. For example, system objects might interface to an “SAP J2EE” system connector that connects to a J2EE system that is not directly visible in the portal interface. Connector objects provide an improvement over the standard way to interface to external objects and present a cleaner API to the portal component and generalize interfaces to external databases.

Each attribute can be described by meta-attributes, such as its scope (e.g., a “Global” meta-attribute indicates attributes applicable to all users and a “Personalized” meta-attribute indicates attributes applicable to one or some users), its requirement (e.g., a “Mandatory” meta-attribute indicates that a value is required for connection to be had and an “Optional” meta-attribute indicates that a value is optional), or its type (e.g., meta-attributes such as “string”, “integer”, “number”, “Boolean” or “enumerated”).

A “system template” can be thought of as the schema of an actual system with a pre-defined set of properties, with or without attendant attribute values. System templates can be created manually using user interface tools, such as property editor 20, but might also be created automatically based on a component that has knowledge of the underlying system behavior. For example, a vendor of a particular system that is to be an external application might provide an XML file that the portal system can convert into a system template or an actual system definition.

A system definition preferably includes a link to the system template it was created from (and those system templates might in turn include links to templates from which they were created). Each system definition and system template might have properties that are “delta” linked inheritance or “copy” linked inheritance. For delta linked inheritance, the child definition or template inherits properties and/or attribute values from its parent and when the parent properties are attribute values change, so does the child. However, for copy linked inheritance, the child definition or template inherits properties and/or attribute values from its parent at creation, but subsequent changes to the parent are not reflected in the child.

A system definition can include values for its inherited properties, but it can also define new properties not present in the parent. Each change in a system template's property-value tuples are automatically reflected in system objects that inherit from that system template, if they have delta linked inheritance.

To facilitate template management and for other uses, some objects might be alias mapped to other objects. For example, a given external application might have several aliases. The aliases are stored in an alias table accessible to the portal server (or other computing system executing portal instructions). More than one alias can point to a given external application, system connector, etc. An alias might be used to name a portal component's code to refer to one of the external applications supported by a portal server. Aliases allow for the declaration of one alias name for a system, object and/or application which several portal components use, and that way it is easily maintained for logical connection between systems and applications. For example, the system object for an R/3 HR system and the system object for an R/3 FI system might inherit from an R/3 template. With aliases, portal code can be written with reference to a particular alias and the portal code can be switched from one system to another just by altering the alias table.

The portals server accesses the portals database and otherwise serves user requests, where the user might be a user at a browser, an administrator performing administrative tasks, such as maintaining the portals database, or the like. In a typical implementation, the portal interface presented to the user is a portal page, wherein information is laid out per the user's specification. The general case is referred to herein as a “system landscape”, where a specific case of a system landscape specifies the information content and sources that are presented to the user. Thus, a system landscape might be thought of as a collection of system descriptions for all the external applications that are needed to generate the information that is to populate a user's portal page. Note that some portal components need not be attached to external applications, as would be the case for portal components that present only information internally available to the portal server or static information or display elements.

In one embodiment, the portal server executes portal components to generate portal snippets where the portal snippets together form the user's display. Some portal snippets, such as a current news, weather or database record snippet, might require the external application in order for the snippet to be useful of fill its expected purpose (e.g., a portal cannot internally determine the weather for a particular city). In those cases, the portal component refers to a system object that in turn refers to a system connection that interfaces to the external application. These references can be done using reference IDs. For example, the portal component includes a parameter that is a reference to the appropriate system description, which is used by a system object when instantiated. That system description might include references to system templates that it inherits from, as well as a reference to the appropriate system connector, either directly or via an alias.

One method for a portal component to connect with the intended system connector is through a request to a service that handles connections. For example, the portal component might use SAP's Connector Service, which returns an initialized handle to a system connector when a connection is requested. This allows for connectors to supply the same API for different external systems even though the external systems might have different APIs. System connector features can be integrated into the system landscape, wherein each system has a “connector factory”. System connectors can be automatically loaded to support active system objects.

A portal component may contain a reference to one or more system object and the reference can be an alias or a direct ID. References that are direct IDs can be JNDI (“Java Naming and Directory Interface”) names, and the JNDI name would be one of the portal components. A portal component may hold references to zero or more systems, and use them at runtime. Some portal components will include a reference to a system along with properties that indicate how to obtain data. Other portal components might perform tasks other than data retrieval, such as data sending, updating and pinging. “Pinging” is a process of sending a message to an external application and looking for a response, usually to determine if the external application is active and if the communication path between the portal component and the external application is operative.

A system object can be treated as a portal component without any real code, as the system object does not need any portal specific code and thus can rely on generic portal system code. The system object reference is held in the profile of the empty portal component as pairs of attributes and values. Using the portal component profile distinguishes between the system objects behavior (logic) and the external system it is using. This also allows for the use of an import/export mechanism without adding semantics. Content export does not need to trigger the export of its related system objects, so it is good to use a system's alias as a reference to that system.

With portal components and systems being independent, maintenance is easier and a portal component might only need a reference to an alias for the external system, while the system object maintains details such as how to connect to the external application, its location, etc.

The system definitions and system templates can be stored in the portals database 18. A system definition might be a set of declarations without programming code. A system template can be a set of declarations, possibly having some place holders. When a vendor or a customer wants to access an external application and does not already have a system definition in the portal server for that external application, the vendor/customer can select a suitable system template and fill in the blanks to create a system definition. System definitions might be stored in XML format.

To “activate” a system, the portal server loads the system object for that system into a system landscape structure maintained by the portal server with data filled in. A utility can read the system object and use that to access the external application, without the designer of the portal component having to deal with exactly how to make the access. The accesses to the external applications could be via RPC, RMI, SOAP, etc. as directed by the system objects used.

The aliases might be stored in the portal database. Some connectors that are used by system objects (or are system objects themselves) include SAP, SIEBEL, PPSFT, JDBC connectors.

FIG. 4 illustrates how, using a graphical user interface, a system object might be created from a system template taken from a system template library. As an example, a user interface might display the contents of the system template object and allow the user to edit the system template object. The system object can then comprise data that need only include the filled-in values for blanks on the system template object and changed values, if any, while the system template object maintains those values that are not changed. In this manner, the system object can contain the template's values by inheritance.

Appendix A illustrates an example system object in XML format.

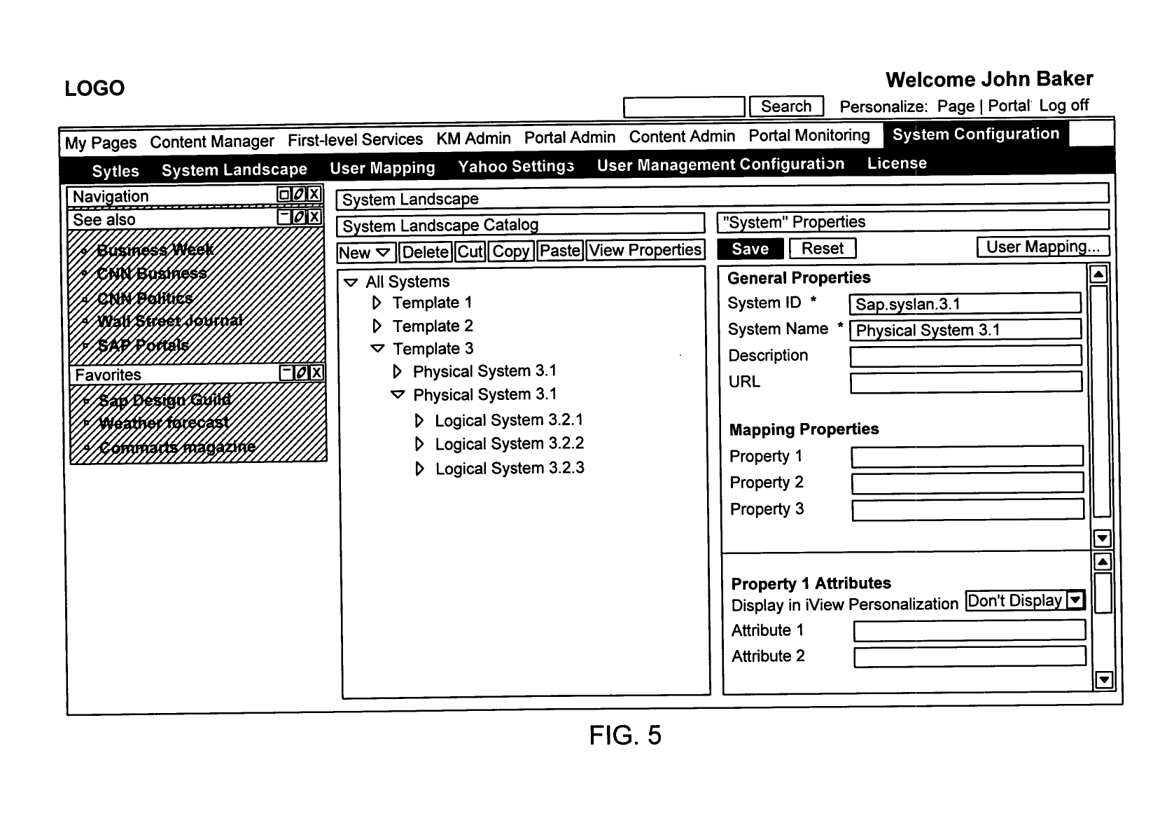

One system landscape catalog structure might have four main levels: 1) All systems, 2) System Templates, 3) Physical Systems, and 4) Logical Systems. This is shown in FIG. 5. Each system inherits all the properties from the “father” system and changes its own copy, and adds new properties according its need. Systems may also be organized in folders. The system landscape framework does not impose any structure. Aliases need not be organized in a structure and can be maintained by the framework.

In a system template, each property can have a meta-property, such as: property=<port #>, value=80, meta-property=“type=int”.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

[image]

[image]

[image]

[image]

[image]

[image]

[image]

[image]

[image]

[image]

[image]

[image]

What is claimed is:

1. An access system that provides access and presentation of data to users wherein data is at least in part extracted from a plurality of external applications, the access system comprising:
storage for a plurality of system templates;
storage for a plurality of system definitions, wherein a system definition includes properties and attributes usable to access an external application from a plurality of external applications to obtain data and wherein at least one system definition has at least one of properties or attributes that are inherited from a system template referenced from the plurality of system templates; and
storage for a plurality of system connectors, wherein a system connector provides an interface to one of the plurality of external applications.

2. The access system of claim 1, wherein at least one of the plurality of system connectors is referenced by a system definition using an alias.

3. The access system of claim 1, wherein the plurality of system templates is arranged as a hierarchy of system templates and at least one lower order system template inherits from at least one higher order system template.

4. The access system of claim 1, wherein the system template is a manually-created system template.

5. The access system of claim 1, wherein the system template is an automatically created system template created from underlying information about the external application.

6. The access system of claim 1, wherein the access system is a client-server system.

7. The access system of claim 1, wherein the access system is a one-tier integrated system with external connectors.

8. The access system of claim 1, wherein the access system comprises a portal system.

9. The access system of claim 1, wherein the plurality of external applications includes at least one database.

10. The access system of claim 1, wherein the storage for the plurality of system definitions has administrative controls to limit reading, writing or modifying of system definitions.

11. The access system of claim 10, w-,herein the administrative controls of lower order system templates are inherited from administrative controls of higher order system templates.

12. The access system of claim 1, wherein attributes include meta-attributes.

13. The access system of claim 12, wherein the meta-attributes include meta-attributes specifying scope, requirements and attribute type.

14. A portal system comprising:
a display system to present a user display;
a portal database including definitions of portal snippets that form user displays;
for each portal snippet that refers to data obtained from an external application, a reference to a system object that in turn refers to a system connection interfacing to the external application, wherein the system object is specified by a system description that includes at least one reference inherited from a system template;
logic that obtains the data as needed from external applications using system objects for each portal snippet that refers to data obtained from an external application.

15. The portal system of claim 14, wherein the system templates form a template hierarchy with lower order system templates inheriting at least one of an attribute, a reference and a property of a higher order system template.

16. The portal system of claim 14 Minton, wherein the system template is arranged as a set of one or more declarations.

17. The portal system of claim 16, wherein the set of one or mote declarations is arranged in XML format.
